(19) United States
(12) Patent Application Publication
(10) Pub. No.: US 2026/0064340 A1
(43) Pub. Date: Mar. 5, 2026

(54) INFORMATION PROCESSING DEVICE

(71) Applicant: SEIKO EPSON CORPORATION, TOKYO (JP)

(72) Inventors: Takuya YAMASHITA, MATSUMOTO-SHI (JP); Yuichi SUGIYAMA, SHIOJIRI-SHI (JP); Ryo ITO, MATSUMOTO-SHI (JP); Yuto FUKUCHI, MATSUMOTO-SHI (JP)

(21) Appl. No.: 19/313,939

(22) Filed: Aug. 29, 2025

(30) Foreign Application Priority Data
Aug. 29, 2024 (JP) 2024-147327

(51) Int. Cl. G06F 3/12

(52) U.S. Cl. CPC G06F 3/1263; G06F 3/1217; G06F 3/1296

(57) ABSTRACT

An information processing device includes: an acquisition unit configured to acquire job data indicating a job to be executed by a printing device; and a display control unit configured to cause a display unit to display a list indicating a printing order of a plurality of jobs, based on the job data, wherein the display control unit causes a display form of the list to be different between when the list includes consecutive jobs that are two or more consecutive jobs and have a common specific attribute and when the list does not include the consecutive jobs.

The present application is based on, and claims priority from JP Application Serial Number 2024-147327, filed Aug. 29, 2024, the disclosure of which is hereby incorporated by reference herein in its entirety.

### BACKGROUND

### 1. Technical Field

The present disclosure relates to an information processing device.

### 2. Related Art

According to the related art, displaying a list of jobs accumulated in a multifunction peripheral is known. JP-A-2015-104863 describes that a user performs an operation such as drag and drop on a displayed job and thus changes the output order of the job in accordance with the position where the job is dropped.

JP-A-2015-104863 is an example of the related art.

When jobs having a common specific attribute are consecutive in a printing order, the work efficiency in the printing process or the post-process after the printing process is high. It is desired that whether jobs having a common specific attribute are consecutive in the printing order is presented so as to be easily recognizable to the user.

### SUMMARY

According to an aspect of the present disclosure, an information processing device includes: an acquisition unit configured to acquire job data indicating a job to be executed by a printing device; and a display control unit configured to cause a display unit to display a list indicating a printing order of a plurality of jobs, based on the job data, in which the display control unit causes a display form of the list to be different between when the list includes consecutive jobs that are two or more consecutive jobs and have a common specific attribute and when the list does not include the consecutive jobs.

### BRIEF DESCRIPTION OF THE DRAWINGS

FIG. 1 is a block diagram of a printing system.

FIG. 2 is a flowchart showing an example of a printing process.

FIG. 3 shows an example of a job list.

FIG. 4 shows an example of a job list.

FIG. 5 shows an example of a job list.

FIG. 6 shows an example of a job list.

FIG. 7 shows an example of a job list.

FIG. 8 shows an example of a job list.

FIG. 9 shows an example of a job list.

FIG. 10 shows an example of a job list.

### DESCRIPTION OF EMBODIMENTS

Embodiments of the present disclosure will be described below in the following order.
(1) First Embodiment
(1-1) Configuration of Printing System
(1-2) Configuration and Display Control of Information Processing Device
(2) Other Embodiments

### (1) First Embodiment

### (1-1) Configuration of Printing System

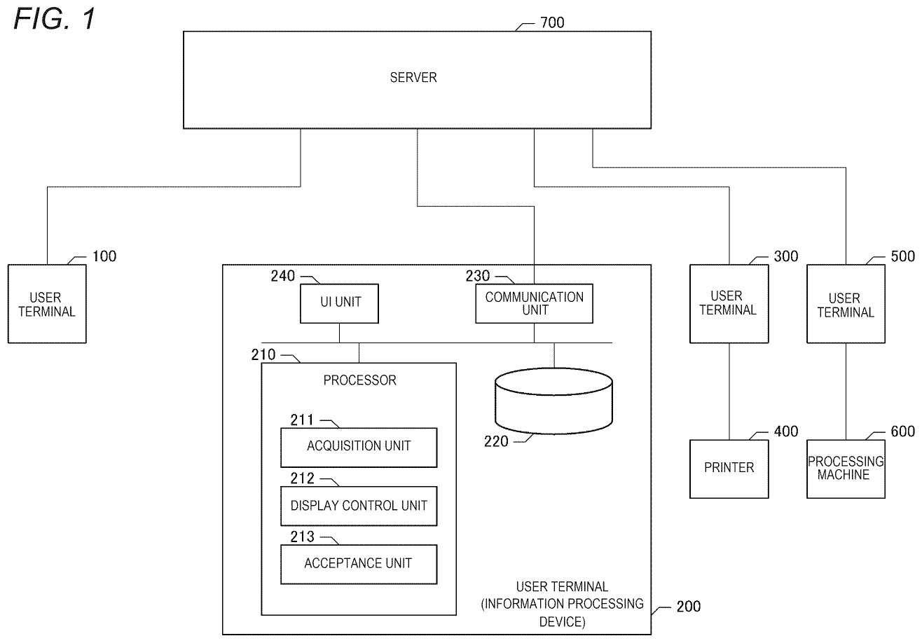

FIG. 1 is a block diagram illustrating an overall configuration of a printing system including a user terminal 200 as an information processing device according to an embodiment of the present disclosure. The printing system according to the present exemplary embodiment is a system that performs a printing process and a post-process after the printing process and thus produces a printed object.

In the present embodiment, the printing system includes user terminals 100, 200, 300, 500, a printer 400 as a printing device, a processing machine 600, and a server 700. These devices can communicate with each other via a network. The network may be in various forms, may be a local network, or may be configured such that devices present at physically separated locations communicate with each other via the internet or the like. The number of devices illustrated in FIG. 1 is an example, and the number of devices is not limited.

The printed object produced in the printing system of the present embodiment is assumed to be a label (seal), and in the printing process, the printer 400 prints a label image on a medium in the form of roll paper, and in the post-process, the processing machine 600 performs die cutting using a blade that matches the shape and size of the contour of the label image, on the medium after printing. The shape of the contour of the label image may differ depending on the job. For example, when label images based on a plurality of jobs are printed on one roll of roll paper, if the shape of the blade in the post-process is different between preceding and succeeding jobs in the printing order, blade replacement work is needed between the jobs in the processing machine 600. When the number of times of the blade replacement work increases, the workload on the operator in the post-process increases. Therefore, it is desirable that the number of times of the blade replacement is small for one roll of roll paper. That is, it is desirable that print jobs using the same type of blade in the post-process are consecutively executed for one roll of medium. In the present embodiment, prior to the printing process, the job manager can change the order of a plurality of print jobs for the same medium so that the number of times of blade replacement in the post-process is reduced. At this time, the user terminal 200 in the present embodiment provides a function of visually assisting and facilitating the order determination work.

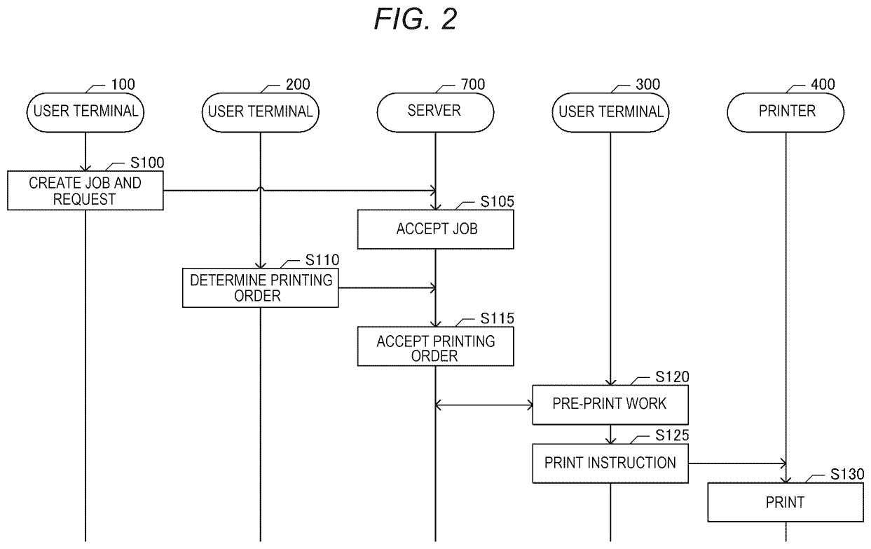

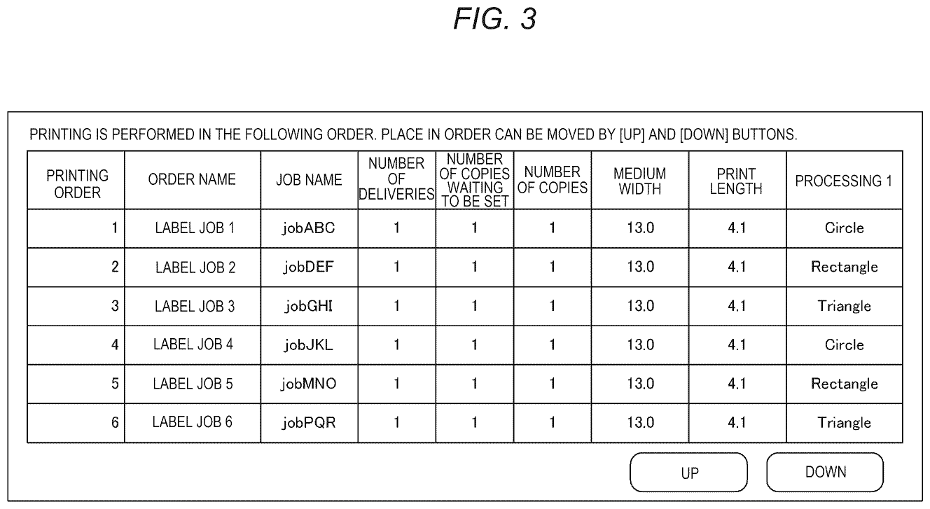

The server 700 is a computer including a processor, a storage medium, a communication unit, and the like, not illustrated. The server 700 has a function of accumulating job data indicating a job to be executed in the printing system, and managing the progress of the job. The job data includes data necessary for the printer 400 or the processing machine 600 to execute a job. For example, the job data includes image data to be printed and data indicating the order name, the job name, the number of deliveries, the number of copies, the medium width, the print length, and the form of processing in the post-process, as illustrated in FIG. 3. The server 700 also adds to the job data (or updates the job data with) data for the server 700 to manage the progress of the job (for example, the number of copies waiting to be set) and data indicating the printing order. The user terminal 100 is a terminal used by a job creator who creates job data. FIG. 2 is a diagram illustrating an example of a flow of the printing process in the present embodiment.

As shown in step S100, the job creator performs an operation of registering job data in the server 700 in order to request the execution of the printing process and the post-process based on the created job data. Examples of the job creator include a designer who determines the design of a label and a sales representative of a printing company owing the printer 400, or the like. When the server 700 receives the job data transmitted from the user terminal 100, the processor of the server 700 accepts the job and saves the job in the storage medium of the server 700 (step S105).

The user terminal 200 is a terminal used by a job manager who determines the execution order of jobs created by the job creator and registered in the server 700. Examples of the job manager include an on-site manager in a printing factory where the printer 400 is installed. The job manager can operate the user terminal 200 to view a list of jobs registered in the server 700. The list of jobs before rearrangement is displayed, for example, in the order of job acceptance. When the job manager determines the printing order by rearranging the jobs (step S110), the server 700 accepts and saves the determined printing order (step S115). Details of step S110 will be described later.

The user terminal 300 is a computer that causes the printer 400 to execute printing based on a job list registered in the server 700. For example, an operator who is a worker in a printing factory checks a list showing the job list registered in the server 700, using the user terminal 300, performs setting work before printing, setting work of a medium to the printer 400, and the like (step S120), and causes the printer 400 to execute printing (step S125). The printer 400 acquires job data (including a printing order) from the server 700 via the user terminal 300 and executes printing based on each job data in the printing order (step S130). On completion of the printing of the job included in the list, the printer 400 notifies the server 700 via the user terminal 300 that the printing is completed. The server 700 updates the data indicating the progress of the job, based on the notification. The operator removes the printed medium from the printer 400.

The operator operates the user terminal 500 to view the job list in the server 700 and checks a job waiting for a post-process using the processing machine 600. The operator also sets the medium corresponding to the job waiting for the post-process (the printed object on which the printing process is completed) in the processing machine 600, sets the blade to be used for the die cutting processing of the medium in the processing machine 600, based on processing information printed on the medium, and causes the processing machine 600 to execute the die cutting processing.

Hereinafter, the user terminal 200 will be described in detail.

### (1-2) Configuration and Display Control of Information Processing Device

The user terminal 200 functioning as an information processing device includes a processor 210, a storage medium 220, a communication unit 230, and a UI unit 240. The processor 210 includes a CPU, a ROM, a RAM, and the like, not illustrated, and can execute various programs stored in the storage medium 220. In the present embodiment, the processor 210 can execute a job display program that provides a job display function of displaying a job registered in the server 700. Note that the processor 210 may be configured with a single chip, may be configured with a plurality of chips, or may be configured as an SoC with various functional blocks that cause the user terminal 200 to operate. Also, an ASIC may be employed instead of the CPU, or the CPU and the ASIC may cooperatively operate. When each device in the present embodiment includes a processor, the processor can be implemented in various forms similar to the processor 210. The job display program may be a program installed in advance and stored in the storage medium 220, or may be a web application that operates on a web browser of the user terminal 200, based on information provided by the server 700.

The communication unit 230 includes a communication interface that communicates with another device according to various protocols for wired or wireless communication. In the present embodiment, the user terminal 200 can communicate with the server 700 via the communication unit 230. The UI unit 240 includes a display, a key, and the like. A device such as a mouse may be connected via the communication unit 230. The display may be a touch panel display. The display functions as a display unit. The processor 210 displays various information on the display and accepts an operation performed on an input unit such as the key, the mouse, or the touch panel.

The processor 210 executes the job display program and thus functions as an acquisition unit 211, a display control unit 212, and an acceptance unit 213. With the function of the acquisition unit 211, the processor 210 acquires job data indicating a job to be executed by the printer 400. That is, in the present embodiment, the processor 210 acquires job data registered in the server 700. With the function of the display control unit 212, the processor 210 displays a list indicating the printing order of a plurality of jobs on the display. FIG. 3 illustrates an example of a GUI and a list in the GUI that are displayed under the control of the display control unit 212 by executing the job display program. The list is a list of jobs registered in the server 700, and in the present embodiment, a list of a plurality of print jobs to be executed on one roll of medium is displayed. In the present embodiment, as shown in FIG. 3, the list is displayed in a form in which the execution of a job is earlier in the printing order as it goes up in the list. Numbers indicating the printing order of jobs are assigned in ascending order from the top of the list. In the example shown in FIG. 3, each job is indicated by an order name or a job name, and attributes such as the number of deliveries, the number of copies waiting to be set, the number of copies, the medium width, the print length, and processing 1 (a form of processing indicating a type of blade in the post-process) are displayed in association with each job. The attributes illustrated in FIG. 3 are examples, and various other data may be displayed in association with each job, or some of the attributes illustrated in FIG. 3 may not be displayed.

With the function of the acceptance unit 213, the processor 210 accepts an operation of changing the order of jobs in the list from the user. When the job manager operates the UI unit 240 to select any job included in the list and change the position in the list, the processor 210 updates the printing order of each job with the printing order corresponding to the changed position. Since the user terminal 200 includes the acceptance unit 213, the job manager can freely change the execution order of the jobs included in the list. More specifically, as shown in FIG. 3, an “up” button and a “down” button are displayed near the list. The change of the order may also be configured such that, by pressing one of these buttons after selecting a job whose place in the printing order is to be changed from the list, the job manager can change the place in the printing order to an earlier place or a later place than the place in the printing order before the button is pressed. The job manager can also change the execution order of the jobs by dragging and dropping the jobs included in the list without using the “up” button or the “down” button. The processing executed by the processor 210 to change the execution order of the jobs as described above is referred to as order change processing. The form of the job manager's operation for rearrangement is not particularly limited.

With the function of the display control unit 212, the processor 210 causes the display form of the list to be different between when the list includes consecutive jobs that are two or more consecutive jobs and have a common specific attribute and when the list does not include the consecutive jobs. In the present embodiment, the specific attribute is an attribute related to the post-process. The attribute related to the post-process is an attribute related to the post-process to be executed after the end of the job executed by the printer 400, and in the present embodiment, the attribute is the type of the blade used in the processing machine 600.

The processor 210 causes the display form to be different between when it is determined that jobs using a common blade are consecutive in the printing order (that is, when the jobs are displayed next to each other in the list) and when it is determined that this condition is not satisfied (that is, when jobs using a common blade are not in the list or when such jobs are present but not consecutive). The processing executed by the processor 210 to determine whether jobs having a common attribute are consecutive is referred to as consecutiveness determination processing. The consecutiveness determination processing is preferably executed each time the order change processing is executed. That is, the processor 210 preferably executes the consecutiveness determination processing, based on the execution of the order change processing.

FIG. 3 illustrates an example in which jobs using a common blade are present in the list (label jobs 1 and 4, label jobs 2 and 5, and label jobs 3 and 6), but these jobs using a common blade are not consecutive in the printing order.

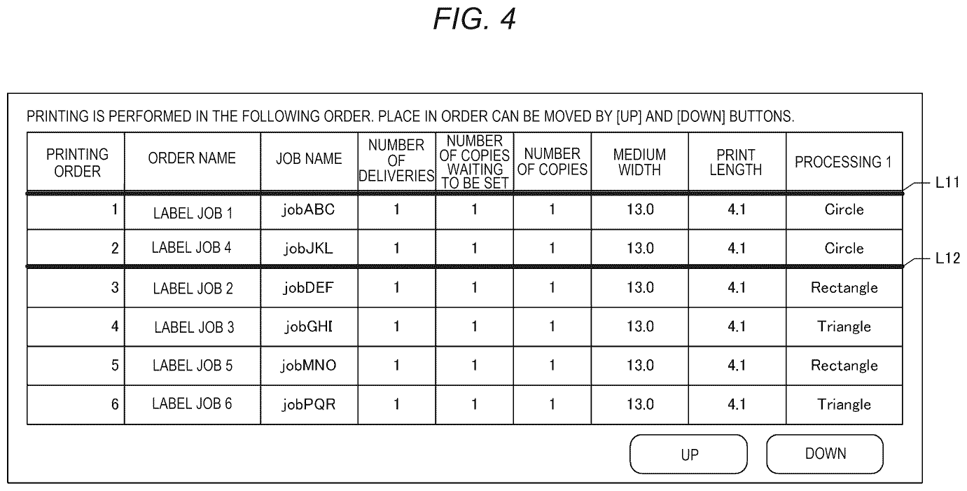

FIG. 4 shows that, as a result of executing the order change processing from the state shown in FIG. 3 and moving the label job 4 to between the label job 1 and the label job 2, the printing order from the earlier position is the label jobs 1, 4, 2, 3, 5, 6. The label job 1 and the label job 4 use the same type of blade, i.e., Circle. Therefore, it means that the jobs are rearranged so that jobs using a common blade are consecutive, and FIG. 4 shows that the list includes consecutive jobs. The processor 210 executes the consecutiveness determination processing, and displays a predetermined geometric shape at a position corresponding to the consecutive jobs in the list, based on the result, when the list includes the consecutive jobs. Meanwhile, the predetermined geometric shape is not displayed at a position that does not correspond to consecutive jobs. In this way, the display form of the list is made different by displaying or not displaying the geometric shape. The method of changing the display form of the list is not particularly limited, and it is sufficient if the user can recognize the difference. For example, a position or a character string corresponding to consecutive jobs in the list may be displayed in a predetermined color, and a position or a character string that does not correspond to consecutive jobs may be displayed in a color different from the predetermined color. In the present embodiment, the predetermined geometric shape is two parallel lines sandwiching consecutive jobs, and lines having a different aspect from a line indicating a boundary of a row indicating each job. Specifically, in the list, lines of the same color or line type (indicated by L11 and L12 (black thick lines) in the example shown in FIG. 4) are displayed at the upper end of the row indicating the job having the earliest place in the printing order among consecutive jobs and the lower end of the row indicating the job having the latest place in the printing order among the consecutive jobs, and it is thus indicated that the jobs sandwiched between such two lines are consecutive jobs. When the list does not include consecutive jobs, the processor 210 does not display a predetermined geometric shape at positions corresponding to the jobs included in the list as shown in FIG. 3. That is, the thick line as shown in FIG. 4 is not displayed at the upper end of the row indicating the label job 1 or the lower end of the row indicating the label job 4.

By displaying the predetermined geometric shape in this manner, the processor 210 causes the display form to be different between when the list includes consecutive jobs and when the list does not include consecutive jobs. Therefore, the job manager can easily recognize whether the list includes consecutive jobs, based on whether the predetermined geometric shape is displayed in the list. Also, when the list includes consecutive jobs, the predetermined geometric shape is displayed at the position corresponding to consecutive jobs and therefore the job manager can easily recognize which jobs in the list are consecutive jobs.

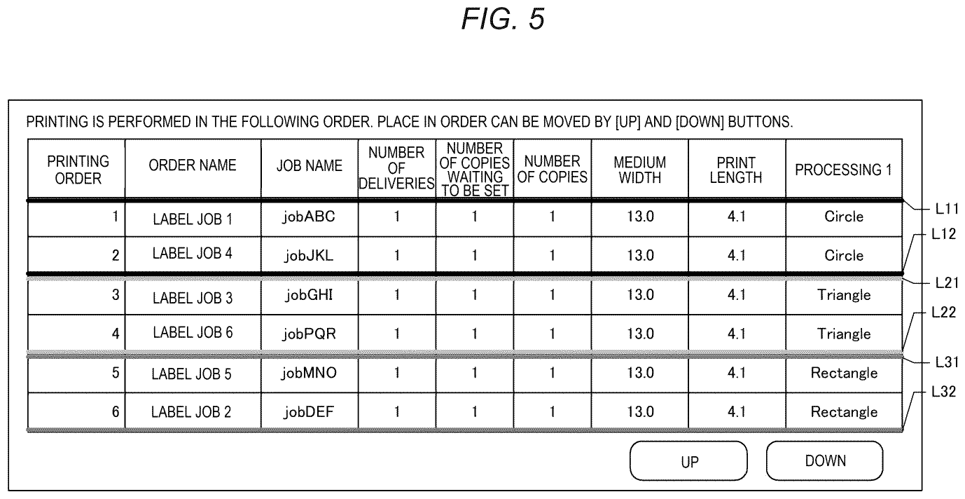

FIG. 5 shows a state where the job manager further rearranges the jobs from the state shown in FIG. 4 so that the label jobs 3 and 6 and the label jobs 5 and 2 become consecutive. The label jobs 3 and 6 have a common blade type of Triangle and are therefore consecutive jobs. Also, the label jobs 5 and 2 have a common blade type of Rectangle and are therefore consecutive jobs. When a plurality of sets of consecutive jobs are present in the list, in the present embodiment, the processor 210 makes the color of the predetermined geometric shape (that is, two lines) different between these sets of consecutive jobs. In the example shown in FIG. 5, lines L11 and L12 sandwiching the label jobs 1 and 4 are shown in black, lines L21 and L22 sandwiching the label jobs 3 and 6 are shown in light gray, and lines L31 and L32 sandwiching the label jobs 5 and 2 are shown in dark gray. In this way, when the list includes a plurality of sets of consecutive jobs, the display form of the predetermined geometric shape is made different from one set of consecutive jobs to another and therefore the job manager can easily recognize the groups of consecutive jobs.

The predetermined geometric shape may be a rectangular frame that surrounds consecutive jobs. In addition to the two lines L11 and L12 shown in FIG. 4, a line connecting the upper left end of the row indicating the job having the earliest place in the printing order among the consecutive jobs and the lower left end of the row indicating the job having the latest place in the printing order, and a line connecting the upper right end of the row indicating the job having the earliest place in the printing order and the lower right end of the row indicating the job having the latest place in the printing order may be displayed, and thus a rectangular frame surrounding the consecutive jobs may be displayed. When the list includes a plurality of sets of consecutive jobs, the rectangular frames corresponding to the respective sets of consecutive jobs may be displayed in different display forms (colors, line types, or the like).

As described above, in the present embodiment, the display form of the list is made different between when the list includes consecutive jobs and when the list does not include consecutive jobs. Therefore, according to the present embodiment, the job manager can easily recognize whether the list includes consecutive jobs.

### (2) Other Embodiments

The foregoing embodiment is an example for carrying out the present disclosure, and various other embodiments can be employed. For example, the product in the printing system is not limited to a label. The product may be completed through the post-process after the printing process, or may be completed without going through the post-process after the printing process. Even when the product is completed through the post-process, the post-process is not limited to the die cutting with the blade, and various post-processes are conceivable as described later.

The printing system described in the above embodiment is an example, and the printing system is not limited to the configuration described in the above embodiment. For example, the job data may be exchanged between the user terminals without using the server. The information processing device according to the present disclosure is not limited to the terminal operated by the job manager described in the above embodiment. For example, the information processing device may be a multifunction peripheral having a printer or a printing function, a terminal operated by the operator of the printing process, or a terminal operated by the job creator, the requester, or another user. The job creation, the determination of the printing order, the pre-printing work, and the print instruction to the printer may be implemented by one information processing device.

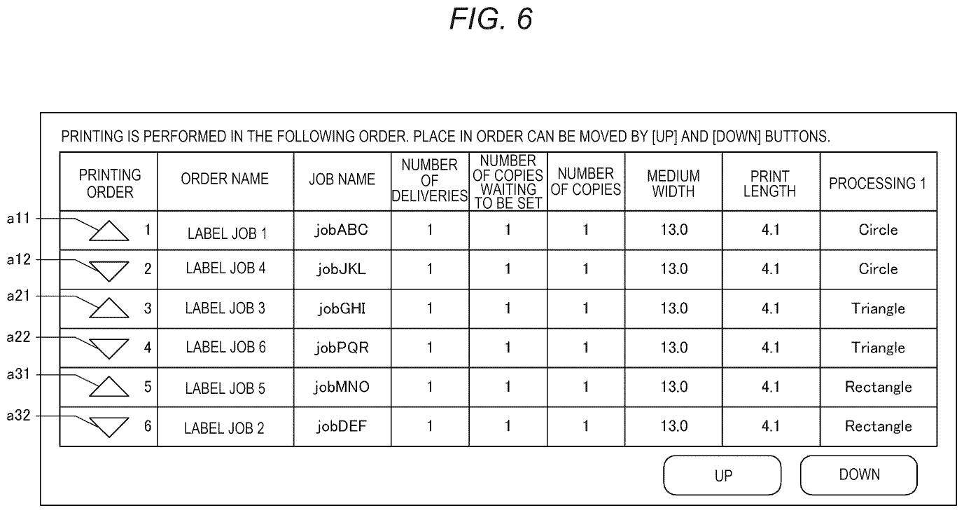

The predetermined geometric shape displayed at the position corresponding to consecutive jobs is not limited to the line or the frame described in the above embodiment. FIG. 6 shows another example of the predetermined geometric shape. In the example shown in FIG. 6, the label jobs 1 and 4, the label jobs 3 and 6, and the label jobs 5 and 2 are consecutive jobs having the blade types of Circle, Triangle, and Rectangle, respectively, which are consecutively used. In the example shown in FIG. 6, triangular arrows a11, a12, a21, a22, a31, a32 shown in the column of the printing order of each job indicate the range of consecutive jobs. That is, an upward (indicating the upward direction) arrow (for example, a11) and a down arrow (a12 in relation to a11) closest to the upward arrow in a row below the row where the upward arrow is displayed indicate the range of consecutive jobs. The jobs corresponding to the rows where the upward arrows a11, a21, a31 are displayed are the jobs having the earliest place in the execution order among the consecutive jobs, and the jobs corresponding to the rows where the downward arrows a12, a22, a32 are displayed are the jobs having the latest place in the execution order among the consecutive jobs. More specifically, the processor 210 determines that the label jobs 4 and 3 are not consecutive jobs (that is, the label job 3 is the job having the earliest place in the execution order among the consecutive jobs) by the consecutiveness determination processing, and displays the upward arrow a21 for the label job 3. Also, the processor 210 determines that the label jobs 6 and 5 are not consecutive (that is, the label job 6 is the job having the latest place in the execution order among the consecutive jobs), and displays the downward arrow a22 for the label job 6.

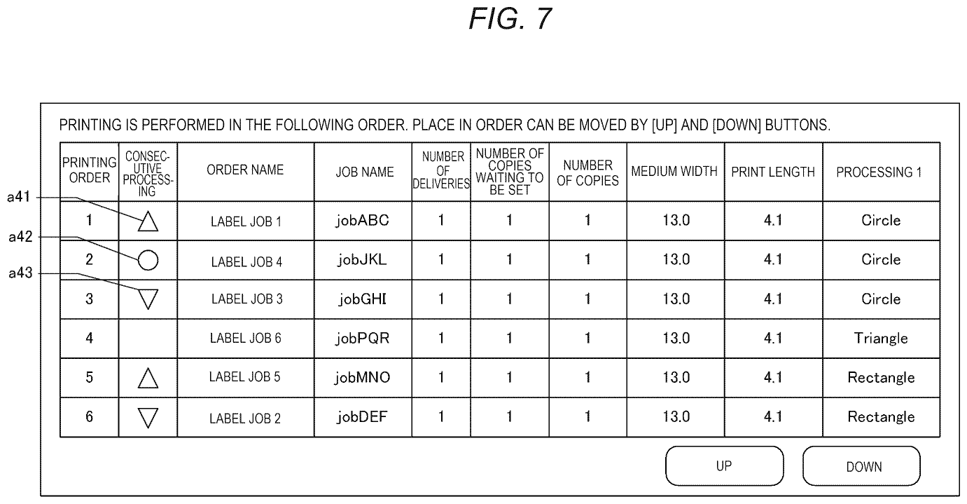

In the example shown in FIG. 6, the consecutive jobs are configured with two jobs each, but when the consecutive jobs are configured with three or more jobs, the consecutive jobs may be displayed as illustrated in FIG. 7. That is, the display control unit may be configured to cause the display form in the list to be different between a job included in the consecutive jobs and having a common attribute with both the preceding and succeeding jobs in the printing order and a job included in the consecutive jobs and having a common attribute with one of the jobs and not having a common attribute with the other job. Specifically, FIG. 7 shows that a pair of an upward arrow a41 and a downward arrow a43 represents a group of consecutive jobs as in the example shown in FIG. 6, and that a circular geometric shape a42 is additionally shown for a job that is neither the first job nor the last job among the consecutive jobs. More specifically, in the example shown in FIG. 7, the label jobs 1, 4, 3 and the label jobs 5, 2 are sets of consecutive jobs having the blade types of Circle and Rectangle, respectively, which are used consecutively. By the consecutiveness determination processing, the processor 210 determines that the label job 1 is the earliest job in the execution order among the jobs included in the consecutive jobs having the blade type of Circle, and displays the upward arrow a41 for the label job 1. Also, the processor 210 determines that the label jobs 3 and 6 are not consecutive jobs (that is, the label job 3 is the job having the latest place in the execution order among the consecutive jobs with the blade type of Circle), and displays the downward arrow a43 for the label job 3. Also, the processor 210 determines that the label job 4 is a job that is consecutive with the label job 1 adjacent to the label job 4 on the earlier side and is consecutive with the label job 3 adjacent to the label job 4 on the later side, that is, a job that is not the first job or the last job among the consecutive jobs having the blade type of Circle, and displays the circular geometric shape a42 for the label job 4. As described above, as different geometric shapes are displayed for the first job, the intermediate job, and the last job of the consecutive jobs, the user can easily recognize the first job, the intermediate job, and the last job.

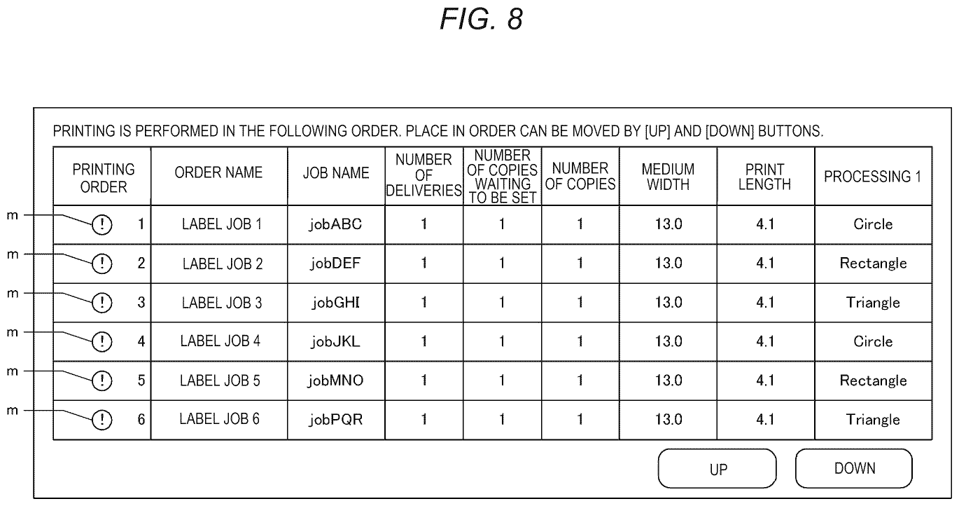

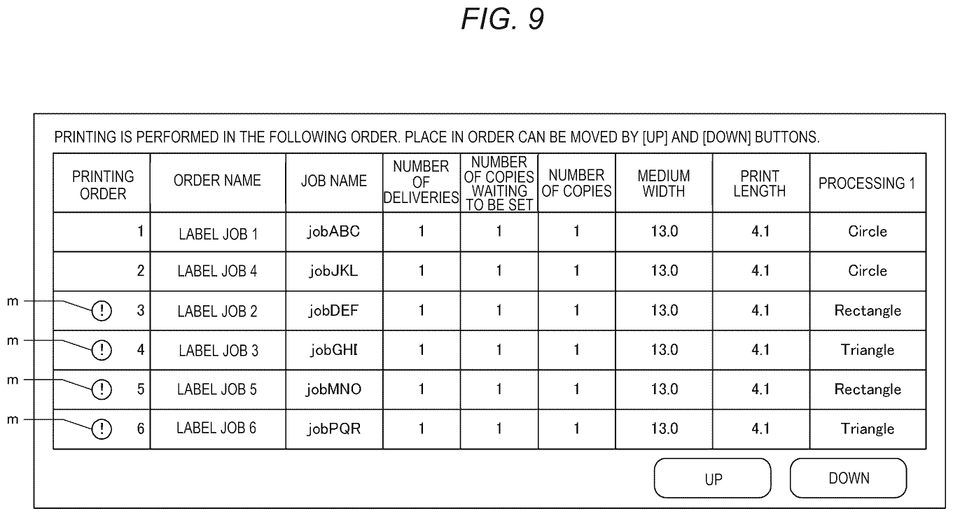

The display control unit may be configured to display the predetermined geometric shape at a position corresponding to each job included in the list when the list does not include consecutive jobs, and to not display the predetermined geometric shape at a position corresponding to consecutive jobs and display the predetermined geometric shape at a position not corresponding to the consecutive jobs when the list includes the consecutive jobs. With this configuration, the user can easily recognize whether the list includes consecutive jobs, based on the presence or absence of the predetermined geometric shape. FIG. 8 shows a display example given when the list does not include consecutive jobs, and FIG. 9 shows a display example given when the label jobs are rearranged from the state shown in FIG. 8 so that the label jobs 1 and 4 become consecutive. That is, when the processor 210 determines that the list does not include consecutive jobs, a predetermined geometric shape m (“!” in the example shown in FIGS. 8 and 9) is displayed for each job included in the list, as shown in FIG. 8, and when the processor 210 determines that the list includes consecutive jobs, the predetermined geometric shape m may not be displayed for a job corresponding to the consecutive jobs, and the predetermined geometric shape m may remain displayed for a job not corresponding to the consecutive jobs, as shown in FIG. 9.

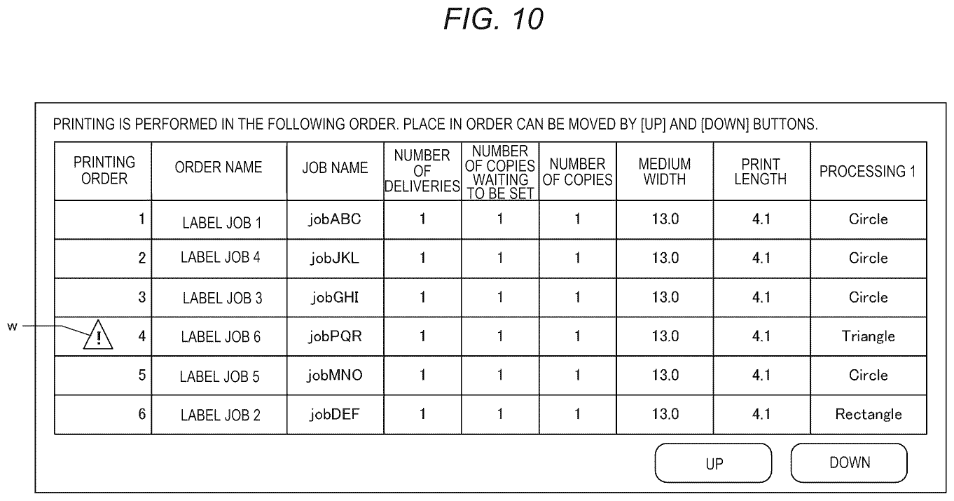

The display control unit may also be configured to display the predetermined geometric shape at a position corresponding to a third job present between the first job and the second job and having a specific attribute that is not common with the first job and the second job, when the first job and the second job having a common specific attribute are not consecutive in the printing order in the list. In FIG. 10, the label jobs that are the first to fifth in the printing order have the common blade type of Circle except for the label job that is the fourth in the printing order. In such a case, the processor 210 may display a predetermined geometric shape w (“!” in a triangle in FIG. 10) at the position (row of the label job 6) corresponding to the label job (third job) that is the fourth in the printing order. As the predetermined geometric shape is displayed in this manner, the user can easily recognize that the fourth label job in the printing order is a job that inhibits the label jobs before and after the fourth label job (the third label job (first job) and the fifth label job (second job) in the printing order) from becoming consecutive in the printing order.

In the above embodiment, the specific attribute used as the condition for consecutive jobs is the attribute related to the post-process of the printing process. The post-process may be one process or a plurality of processes. The post-process may include cutting by a cutting plotter, foil stamping, lamination, and the like in addition to the die cutting using the blade described in the above embodiment. Since jobs having the common attribute related to the post-process are consecutive, the workload in the post-process can be reduced as compared with when the jobs are not consecutive.

The specific attribute may be various other aspects in addition to an attribute related to the post-process. The specific attribute may be an attribute related to a medium type used by the printing device when executing the job. The attribute related to the medium type is, for example, the material of the medium, the width of the medium, or the like. In the first embodiment, print jobs for the same type of medium are listed in the list, but print jobs for different types of media may also be displayed in the same list. In such a case, when the print jobs for the same medium are consecutive, the list may be regarded as including consecutive jobs, and when the print jobs for the same medium are not consecutive, the list may be regarded as not including consecutive jobs. With this configuration, the user can easily recognize whether the attribute related to the medium type is common. When jobs having a common attribute related to the medium type are consecutive in the printing order, the number of times of medium replacement in the printing process (also in the post-process when the post-process is performed) can be reduced. Also, a guidance indicating that the number of times of medium replacement can be reduced when jobs for the common medium type are consecutive may be given.

The specific attribute may be related to the ink type used by the printing device when executing the job. For example, in the printing process, a white ink or a varnish ink may be replaced, depending on the job. In the case of textile printing, a special color ink may be replaced. The number of times of ink replacement work can be reduced by consecutively executing jobs using ink of the same color (a guidance to this effect may be given). Also, for example, since the white ink easily settles, it is more efficient to consecutively use the ink and keep the ink in a stirred state.

The specific attribute may be an attribute related to the destination of delivery of a printed object printed by the execution of a job. When jobs having the common destination of delivery are consecutively printed, packaging materials and preparations for transportation can be put together, which is efficient. Also, a guidance and suggestion to that effect may be given.

The specific attribute may be an attribute related to the delivery date of the job. When printing is performed collectively for each delivery date, the time and effort to put together printed objects having the same delivery date can be reduced. The delivery date is not limited to the same date, and jobs whose delivery date is within a predetermined period may be consecutively printed. In this case, a guidance or a suggestion may be made so that the printing order is determined such that the delivery data of the job becomes earlier as it goes toward the outer side of one completed roll of object to be delivered (for example, in the case of a printed object completed by only one printing process, a job with an earlier delivery date is printed later, or the like).

The display control unit may be configured to accept a designation of any one attribute among a plurality of attributes of the job and set jobs in which the designated attribute is the common, as consecutive jobs. That is, jobs in which any one attribute designated by the user is the common and which are consecutive in the printing order may be regarded as consecutive jobs, and the display form thereof may be made different in any one of the foregoing manners. With such a configuration, a guidance to consecutive jobs that meet the needs of the user can be given intelligibly. The number of attributes that can be designated by the user may be N that is two or more (N being an integer equal to or greater than two). When the user designates N attributes, jobs in which the N attributes are common and which are consecutive in the printing order may be regarded as consecutive jobs.

Note that the user may not designate an attribute to be the condition of consecutive jobs. That is, among a plurality of attributes of jobs, jobs in which any two or more attributes are common and which are consecutive in the printing order may be set as consecutive jobs. With this configuration, even when the consecutive jobs are included in the list without the user's awareness, the user can recognize that the consecutive jobs are included. Also, which attribute is common may be presented to the user. Also, the display form may be made different between when one attribute is common and the jobs are consecutive in the printing order, when two attributes are common and the jobs are consecutive in the printing order, and when three attributes are common and the jobs are consecutive in the printing order.

In the first embodiment, it is assumed that a plurality of print jobs are executed for one roll of medium (that is, it is assumed that the medium type is the same type), but in the printing process, the type (for example, the width or the like) of medium to be used may be different depending on the job. The list may be displayed, including print jobs for different medium types. In such a case, when jobs in which both the attribute related to the medium type and the attribute related to the post-process are common are consecutive, the jobs may be regarded as consecutive jobs.

The present disclosure is also applicable to a program executed by a computer and a method. The system, the program, and the method as described above may be implemented as a single device or may be implemented by using components provided in a plurality of devices, and may include various forms. Also, the present disclosure may be changed as appropriate, such as a part being software and a part being hardware. Moreover, the present disclosure can be applied as a recording medium storing a program that controls the system. Obviously, the recording medium storing the program may be a magnetic recording medium or may be a semiconductor memory, and any recording medium to be developed in the future can be similarly employed.

What is claimed is:

1. An information processing device comprising:
an acquisition unit configured to acquire job data indicating a job to be executed by a printing device; and
a display control unit configured to cause a display unit to display a list indicating a printing order of a plurality of jobs, based on the job data, wherein
the display control unit causes a display form of the list to be different between when the list includes consecutive jobs that are two or more consecutive jobs and have a common specific attribute and when the list does not include the consecutive jobs.

2. The information processing device according to claim 1, wherein
the display control unit causes the display form to be different by displaying a predetermined geometric shape at a position corresponding to the consecutive jobs in the list and not displaying the predetermined geometric shape at a position not corresponding to the consecutive jobs in the list when the list includes the consecutive jobs, and not displaying the predetermined geometric shape in the list when the list does not include the consecutive jobs.

3. The information processing device according to claim 1, wherein
the display control unit causes the display form in the list to be different between
a job included in the consecutive jobs and having the attribute common to both preceding and succeeding jobs in a printing order and
a job included in the consecutive jobs and having the attribute common to one of the jobs and not common to the other job.

4. The information processing device according to claim 1, wherein
the display control unit displays a predetermined geometric shape at a position corresponding to each job included in the list when the list does not include the consecutive jobs, and does not display the predetermined geometric shape at a position corresponding to the consecutive jobs and displays the predetermined geometric shape at a position not corresponding to the consecutive jobs when the list includes the consecutive jobs.

5. The information processing device according to claim 1, further comprising:
an acceptance unit configured to accept an operation of changing an order of jobs in the list from a user.

6. The information processing device according to claim 1, wherein
the specific attribute relates to a medium type used by the printing device when executing a job.

7. The information processing device according to claim 1, wherein
the specific attribute relates to an ink type used by the printing device when executing a job.

8. The information processing device according to claim 1, wherein
the specific attribute relates to a post-process executed after a job executed by the printing device ends.

9. The information processing device according to claim 1, wherein
the specific attribute relates to a destination of delivery of a printed object printed by execution of a job.

10. The information processing device according to claim 1, wherein
the specific attribute relates to a delivery date of a job.

11. The information processing device according to claim 1, wherein
a designation of any one attribute among a plurality of attributes of jobs is accepted, and jobs that are consecutive and have a common designated attribute are set as the consecutive jobs.
